(19) United States
(12) Patent Application Publication
(10) Pub. No.: US 2026/0350717 A1
(43) Pub. Date: Nov. 5, 2026

(54) SYSTEMS AND METHODS FOR ANALYZING AGRICULTURAL INDUSTRY AREAS

(71) Applicant: TimberSync, LLC, Versailles, KY (US)

(72) Inventors: John Andrew C. Heinle, Lexington, KY (US); Edward Phillip Novis, Missoula, MT (US)

(21) Appl. No.: 19/665,655

(22) Filed: May 1, 2026

Related U.S. Application Data
(60) Provisional application No. 63/798,272, filed on May 1, 2025.

(51) Int. Cl. G06Q 50/02; G05D 1/648

(52) U.S. Cl. CPC G06Q 50/02; G05D 1/648

(57) ABSTRACT

Systems and methods for analyzing agricultural industry areas are provided. One embodiment of a method includes receiving data associated with a plurality of parcels of land, determining a candidate parcel for asset extraction from the data associated with the plurality of parcels of land, and commissioning a mobile device to the candidate parcel to perform an audit of the plurality of assets on the candidate parcel. Some embodiments include determining whether the audit is favorable, determining a likelihood of a landowner granting permission to remove at least a portion of the plurality of assets on the candidate parcel, and acquiring permission to remove at least a portion of the plurality of assets on the candidate parcel. Some embodiments, in response to acquiring permission to remove at least a portion of the plurality of assets on the candidate parcel, remove the portion of the plurality of assets.

### CROSS REFERENCE

This application claims the benefit of U.S. Provisional Application Ser. No. 63/798,272, filed May 1, 2025, which is hereby incorporated by reference in its entirety.

### COLOR DRAWINGS

The patent or application file contains at least one drawing executed in color. Copies of this patent or patent application publication with color drawing(s) will be provided by the Office upon request and payment of the necessary fee.

### TECHNICAL FIELD

Embodiments provided herein generally relate to systems and methods for analyzing agricultural industry areas, including for timber, hunting, agriculture, renewable energy, conservation, or other land-based resource industries and, more specifically, to embodiments for determining available areas for utilization.

### BACKGROUND

In many agricultural and land-use industries, such as logging, hunting, and the development of wind farms or solar farms, an initial step often involves identifying one or more areas of land on which to perform a desired activity. In the logging industry, a substantial portion of harvested timber originates from privately owned properties rather than publicly held land. In some regions, the majority of timber production may depend on private landowners who elect to sell or otherwise make available timber resources on their properties. Accordingly, logging companies and timber purchasers frequently rely on private landowners to initiate contact regarding potential harvesting opportunities.

While landowner-initiated arrangements may be effective in certain circumstances, they can depend on several factors that are not always present. For instance, a landowner may lack accurate or timely information regarding the quantity, quality, or market value of natural resources on the land. In addition, some landowners may be unaware that their property is suitable for a particular use, such as timber harvesting, wildlife management, or renewable energy development. Others may possess such knowledge but may be unmotivated or uncertain about how to proceed, including how to identify qualified buyers, evaluate competing offers, or navigate regulatory, environmental, or contractual considerations. In some embodiments, landowner attributes are maintained separately from parcel attributes and are conditionally linked based on current ownership.

From the perspective of entities seeking to acquire land rights or natural resources, traditional approaches to identifying suitable properties may be labor-intensive, inefficient, or incomplete. For example, companies may rely on manual surveys, personal networks, public records, or generalized geographic information to identify potential properties. Such methods can be time-consuming, may fail to identify optimal or underutilized parcels, and may not scale effectively across large geographic regions. Additionally, these approaches may not readily incorporate real-time data, historical land-use information, or predictive indicators of future suitability.

Similar challenges arise in other land-based industries. Hunting and recreational land use can require identifying properties with particular wildlife populations, terrain characteristics, or access constraints. Renewable energy development, such as wind or solar projects, may require land with specific topographical, environmental, and infrastructural attributes, as well as receptive landowners. In each case, inefficiencies in identifying and evaluating suitable land can lead to missed opportunities, increased costs, or suboptimal development outcomes.

Accordingly, there exists a need for improved systems and methods that facilitate the identification, evaluation, and engagement of landowners and land parcels for agricultural, natural resource, and land-use activities. Such systems and methods may, in some embodiments, reduce reliance on landowner-initiated contact, improve visibility into land attributes and potential uses, and enable more informed decision-making by both landowners and interested parties. The present disclosure is directed to addressing these and other considerations.

### SUMMARY

Systems and methods for analyzing agricultural industry areas are provided. One embodiment of a method includes receiving data associated with a plurality of parcels of land, determining a candidate parcel for asset extraction from the data associated with the plurality of parcels of land, and commissioning a mobile device to the candidate parcel to perform an audit of the plurality of assets on the candidate parcel. Some embodiments include determining whether the audit is favorable, determining a likelihood of a landowner granting permission to remove at least a portion of the plurality of assets on the candidate parcel, and acquiring permission to remove at least a portion of the plurality of assets on the candidate parcel. Some embodiments, in response to acquiring permission to remove at least a portion of the plurality of assets on the candidate parcel, remove the portion of the plurality of assets.

In another embodiment, a system includes a remote computing device that includes a processor and a memory component. The memory component may be configured to store logic that, when executed by the processor, causes the system to receive data associated with a plurality of parcels of land, where the data associated with the plurality of parcels of land includes satellite imagery of the plurality of parcels of land and determine a candidate parcel for timber extraction from the data associated with the plurality of parcels of land. In some embodiments, determining the candidate parcel includes determining a plurality of value parameters for the plurality of parcels of land based on a plurality of trees on the plurality of parcels of land, comparing each of the plurality of value parameters, and determining which of the plurality of value parameters meets a predetermined threshold. In some embodiments, the logic causes the system to commission a mobile device to the candidate parcel to perform an audit of the plurality of trees on the candidate parcel, determine whether the audit is favorable, and acquire permission to remove at least a portion of the plurality of trees on the candidate parcel. In some embodiments, in response to acquiring permission to remove at least a portion of the plurality of trees on the candidate parcel, the logic may cause removal of the portion of the plurality of trees.

In yet another embodiment, a system includes a robotic vehicle for automatically and without human intervention traversing a candidate parcel and a remote computing device that includes a processor and a memory component. The memory component may be configured to store logic that, when executed by the processor, causes the system to receive data associated with a plurality of parcels of land, where the data associated with the plurality of parcels of land includes satellite imagery of the plurality of parcels of land, and determine the candidate parcel for timber extraction from the data associated with the plurality of parcels of land. Determining the candidate parcel may include determining a plurality of value parameters for the plurality of parcels of land based on a plurality of trees on the plurality of parcels of land, comparing each of the plurality of value parameters, and determining which of the plurality of value parameters meets a predetermined threshold. In some embodiments, the logic causes the system to commission the robotic vehicle to perform an audit of the plurality of trees on the candidate parcel, determine whether the audit is favorable, and acquire permission to remove at least a portion of the plurality of trees on the candidate parcel. In some embodiments, the logic, in response to acquiring permission to remove at least a portion of the plurality of trees on the candidate parcel, may cause removal of the portion of the plurality of trees. In some embodiments, the logic causes the system to automatically modify selection criteria when determining a next candidate parcel for timber extraction, based on an accuracy of the value parameters.

In another embodiment a method may include receiving, by a computing device, remote data associated with a plurality of parcels, where the remote data includes parcel data and landowner data, generating, by the computing device, a parcel attribute of the plurality of parcels, based on the parcel data, and selecting, by the computing device, a first parcel of the plurality of parcels, based on the parcel attribute. In some embodiments, the method further includes receiving, by the computing device, structured field observations associated with the first parcel, where the structured field observations includes categorical inputs and quantitative inputs, updating, by the computing device, the parcel attribute based on the structured field observations, and associating, by the computing device, the landowner data with the first parcel, where the landowner data is conditionally linked to the first parcel based on ownership. In some embodiments, the method further includes reconciling, by the computing device, the structured field observations associated with the first parcel to determine a confidence level, applying, by the computing device, a parcel scoring model to the first parcel based on the structured field observations, and automatically modifying, by the computing device, selection criteria of a second parcel based on the parcel attribute and the parcel scoring model of the first parcel.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

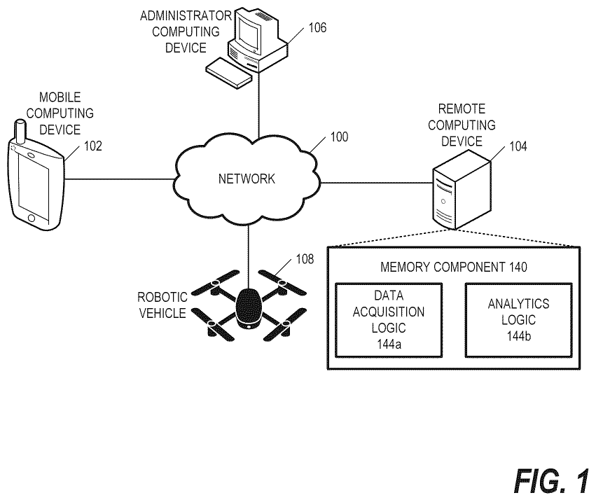

FIG. 1 depicts a computing environment for analyzing agricultural industry areas, according to embodiments provided herein;

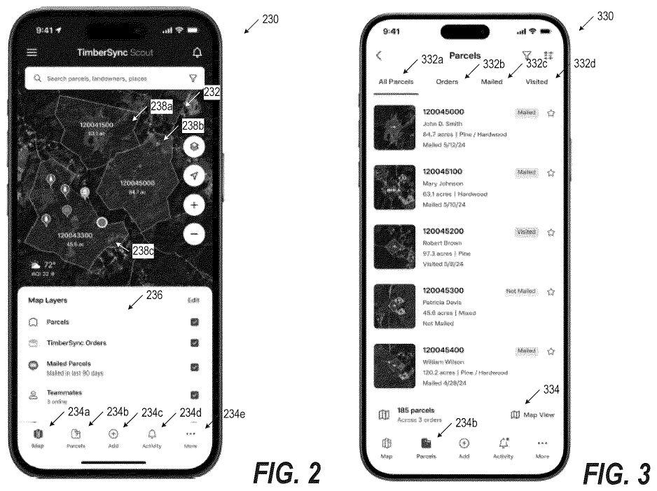

FIG. 2 depicts a mobile interface for analyzing agricultural industry areas, according to embodiments provided herein;

FIG. 3 depicts another mobile interface for providing data related to one or more parcels for analysis, according to embodiments provided herein;

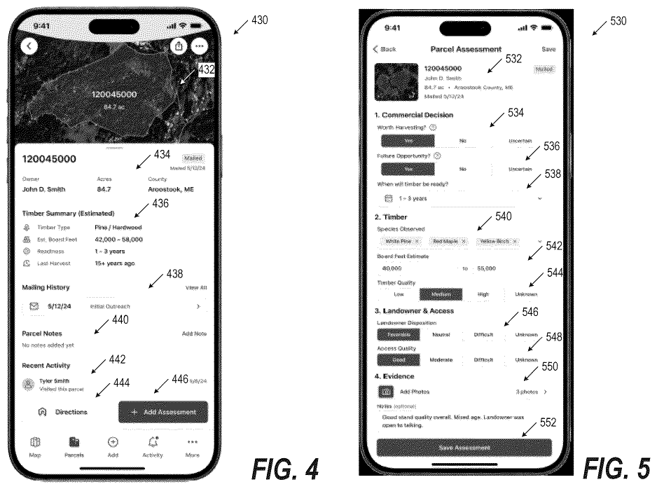

FIG. 4 depicts a mobile interface for providing data related to a particular parcel, according to embodiments provided herein;

FIG. 5 depicts a mobile interface for providing a parcel assessment, according to embodiments provided herein;

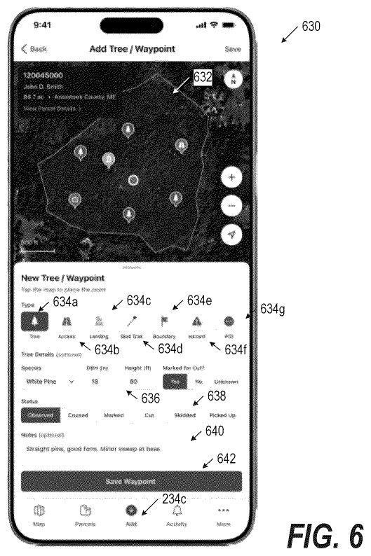

FIG. 6 depicts a mobile interface for providing a waypoint on a parcel, according to embodiments provided herein;

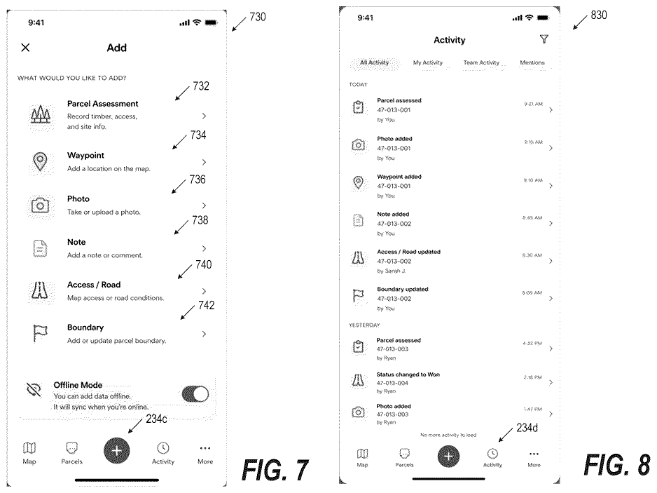

FIG. 7 depicts a mobile interface for adding content to a parcel profile, according to embodiments provided herein;

FIG. 8 depicts a mobile interface for monitoring activity for a parcel, according to embodiments provided herein;

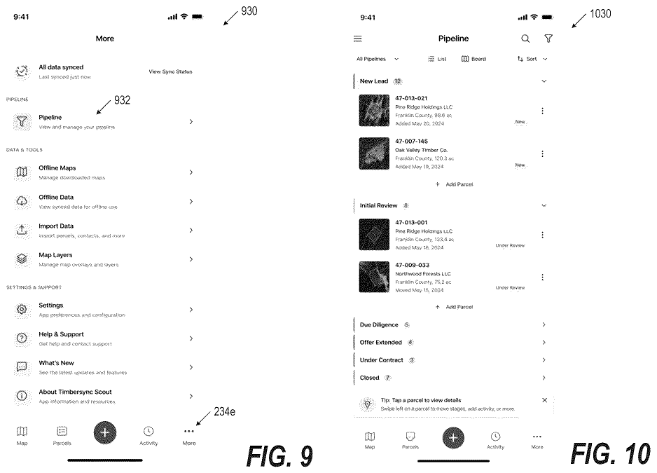

FIG. 9 depicts a mobile interface for providing additional options for a parcel, according to embodiments provided herein;

FIG. 10 provides a mobile interface for providing a pipeline for a parcel, according to embodiments provided herein;

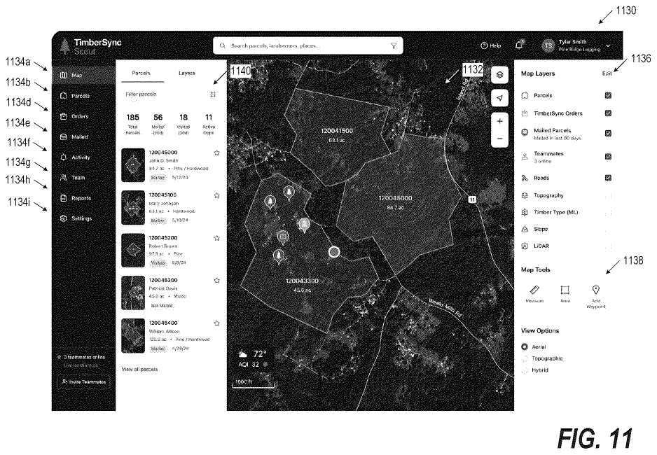

FIG. 11 depicts a desktop interface for providing a map related to one or more parcels for analysis, according to embodiments provided herein;

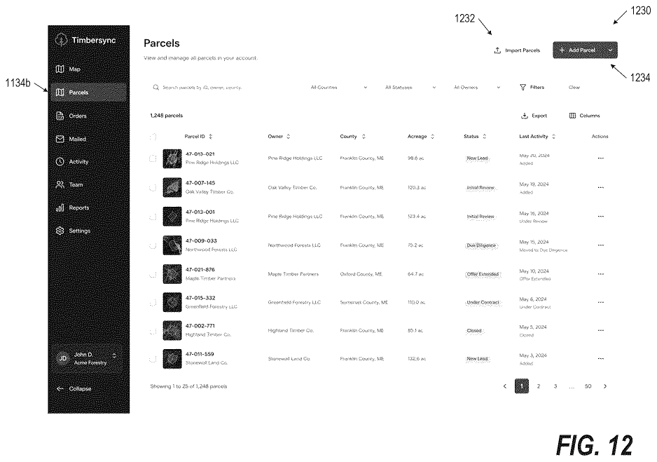

FIG. 12 depicts a desktop interface for providing a parcel assessment, according to embodiments provided herein;

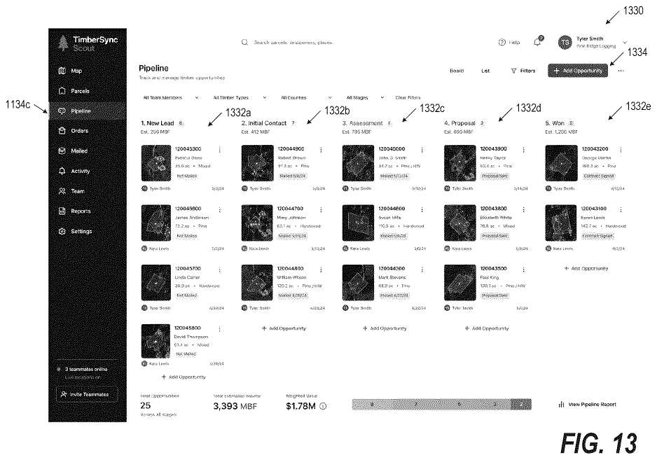

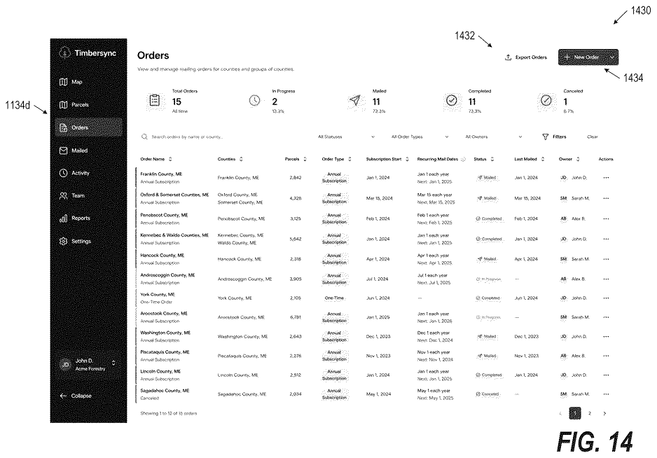

FIG. 13 depicts a desktop interface for providing a pipeline of parcels for analysis, according to embodiments provided herein;

FIG. 14 depicts a desktop interface for providing an order listing for a parcel, accordioning to embodiments provided herein;

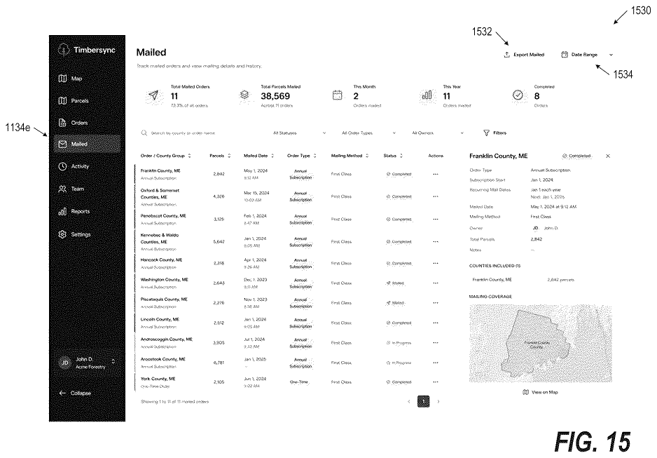

FIG. 15 depicts a desktop interface for providing an outreach history for a parcel, according to embodiments provided herein;

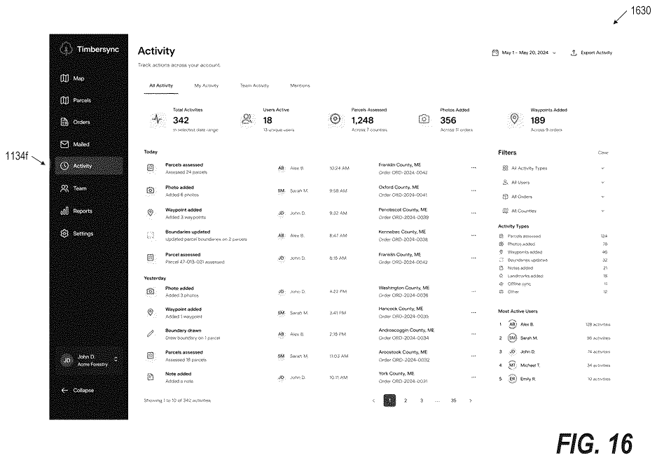

FIG. 16 depicts a desktop interface for providing an activity history for a parcel, according to embodiments provided herein;

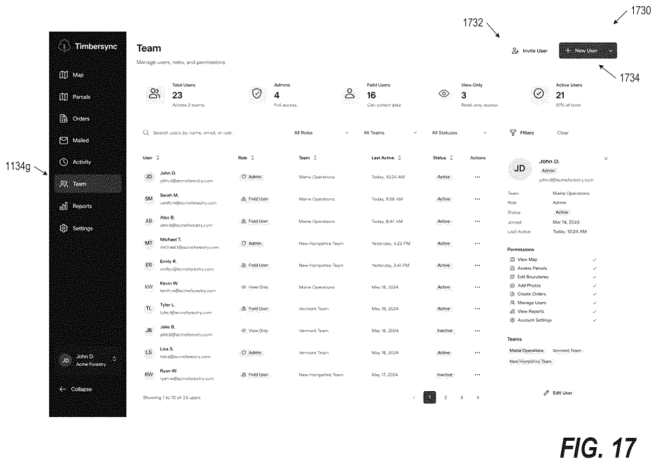

FIG. 17 depicts a desktop interface for providing a team listing for a parcel, according to embodiments provided herein;

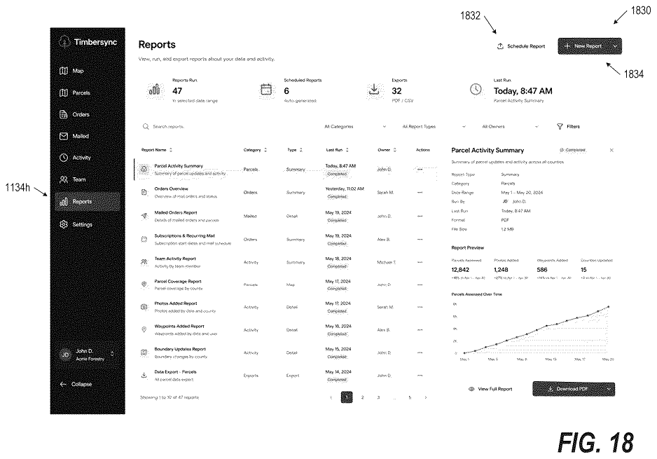

FIG. 18 depicts a desktop interface for providing a reports listing for a parcel, according to embodiments provided herein;

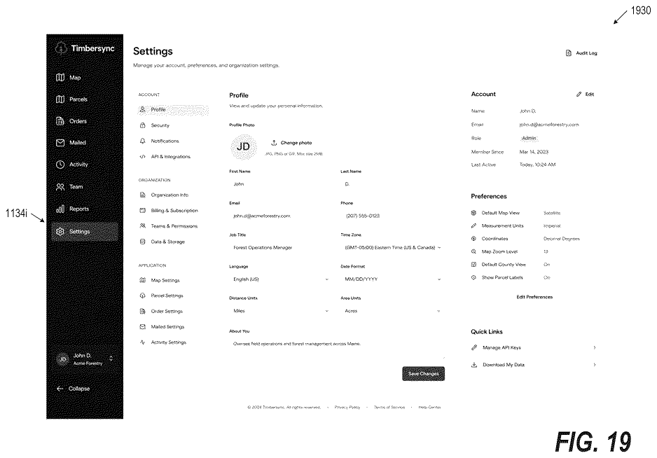

FIG. 19 depicts a desktop interface for providing system settings, according to embodiments provided herein;

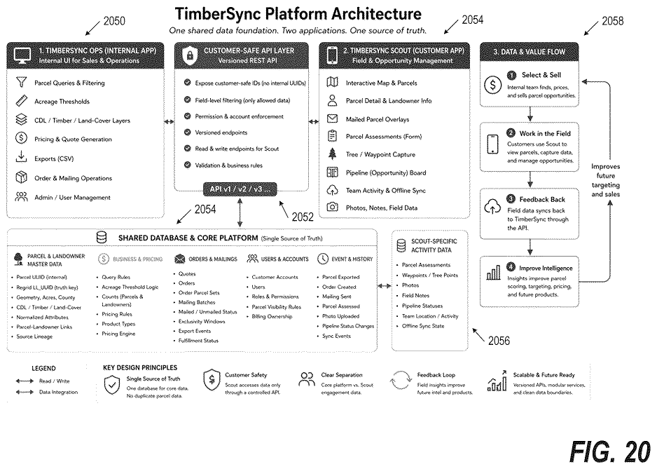

FIG. 20 depicts a flow diagram for analyzing agricultural industry areas, according to embodiments provided herein;

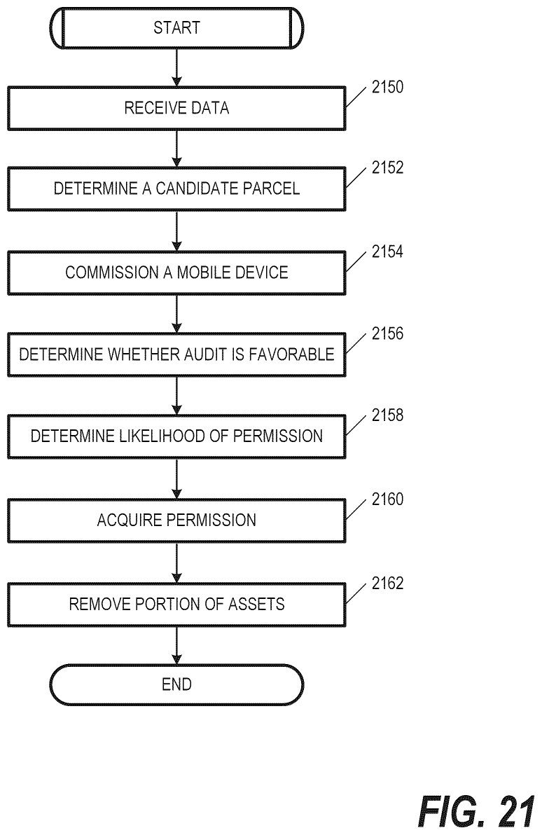

FIG. 21 depicts a flowchart for analyzing agricultural industry areas, according to embodiments provided herein;

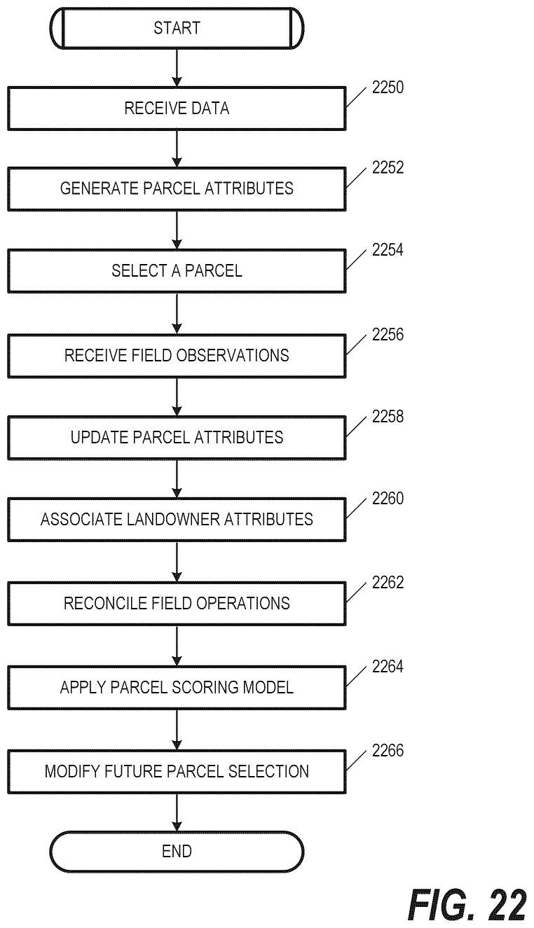

FIG. 22 depicts another flowchart for analyzing agricultural industry areas, according to embodiments provided herein; and

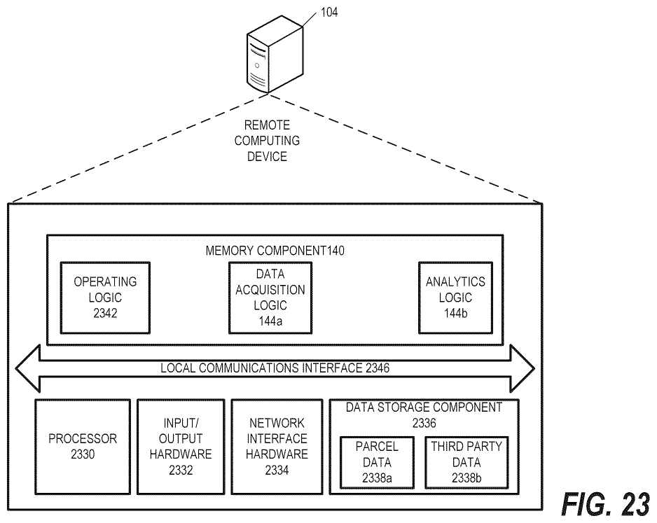

FIG. 23 depicts a computing device for analyzing agricultural industry areas, according to embodiments provided herein.

### DETAILED DESCRIPTION

Embodiments disclosed herein include systems and methods for analyzing agricultural industry areas. These embodiments may be configured for separation of parcel attributes versus landowner attributes, ownership-dependent landowner data (applies while ownership persists), conflict resolution across multiple observations, confidence scoring tied to observation consistency, automatic re-ranking and inclusion/exclusion from future campaigns, and longitudinal parcel history.

As such, some embodiments include a feedback-driven intelligence layer configured to continuously update parcel-level and landowner-level data based on structured field observations. Field observations received from one or more user devices may be normalized into a structured schema and associated with a specific parcel and, where applicable, a landowner.

Some embodiments may be configured to update parcel attributes including, but not limited to, commercial viability, resource estimates, access characteristics, and readiness timing based on the structured field observations. In some embodiments, these updates override or recalibrate attributes previously inferred from remote data sources.

Embodiments may additionally associate landowner-specific attributes, including disposition, responsiveness, and transaction preferences, with a parcel. Such landowner attributes may be conditionally applied based on ownership and may be decoupled upon a change in ownership.

In some embodiments, multiple observations associated with a parcel may be reconciled to determine consistency, where consistent observations increase confidence and conflicting observations reduce confidence or trigger review. These embodiments may maintain a longitudinal history of parcel observations over time.

In some embodiments, structured field observations are used to update one or more predictive models associated with parcel scoring, classification, or prioritization. The models may be updated by adjusting weights, incorporating new training data, or modifying classification thresholds.

Updated parcel intelligence may be used to automatically re-rank parcels, include or exclude parcels from future outreach or targeting campaigns, and adjust selection criteria for identifying additional parcels. In some embodiments, patterns identified from field observations may be applied to other parcels with similar characteristics to influence future targeting decisions.”

Some embodiments may be configured to facilitate identification of a candidate parcel of land. These embodiments may be configured to digitally analyze satellite images, topography maps, landowner registries, etc. to determine a candidate parcel of land, as well as assess that candidate parcel's possibility for value (e.g., such as for timber). Other analysis may be performed related to the landowner, such as whether the parcel is a primary residence, whether the parcel is a multi-generational family asset, etc. to determine whether the landowner would likely be willing to grant access to the timber and/or other natural resource. Upon providing this initial assessment, the data may be presented to an administrator and/or computing device, who may commission physical analysis of the property. The physical analysis of the property may take the form of a robotic vehicle (such as an aerial vehicle, a terrestrial vehicle, etc.) and/or human surveying the parcel with the assistance of a mobile computing device to determine the actual inventory of a predetermined asset. In the timber industry, this might include the robotic vehicle taking video and/or still pictures of the trees in the parcel and a remote computing device using image recognition techniques (such as via a machine learning platform) to inventory the types, health, sizes, age, value, and/or other information for each asset on the parcel (or a predetermined area on the parcel).

Some embodiments may be configured to determine the desired mechanism for approaching the landowner about entering into an agreement for permission to access the predetermined assets. Options include a phone call, in person contact, email, registered mail, etc., as well as the information provided in the communication. In some embodiments, the computing device may categorize each parcel into a plurality of categories. Based on responses by the landowners, the categorization may be based on the status of the assets on the property, the current value of the assets, the future value of the assets, etc. Additionally, the parcel may be categorized for future contact at a predetermined later date.

As one example, if the landowner is unwilling to engage, embodiments may monitor the community's property owner database, such that if/when the property ownership changes, the new landowner may be promptly contacted. In some embodiments, the value of assets may be determined, as well as a projection of the value in 5, 10, 15, 20, etc. years. Based on the projected future value and the time to reach a predetermined threshold value, timing of contacting the landowner may be determined. The systems and methods for analyzing agricultural industry areas incorporating the same will be described in more detail, below.

Referring now to the drawings, FIG. 1 depicts a computing environment for analyzing agricultural industry areas, according to embodiments provided herein. As illustrated, the computing environment may include a network 100 coupled to a mobile computing device 102, a remote computing device 104, an administrator computing device 106 and a robotic vehicle 108. The network may include any wide area network (WAN), such as the internet, public switch telephone network, cellular network, etc., local network (such as a local area network (LAN), wireless-fidelity (Wi-Fi), Ethernet, etc., and/or personal area network (PAN), such as Bluetooth, Zigbee, a wired connection, etc. for communicating data between the components provided in FIG. 1.

The mobile computing device 102 may be configured as a mobile phone, personal digital assistant, tablet, laptop computer, or other computing device that is capable of operating in various environments. The mobile computing device 102 may include a display for providing user interfaces (such as those described below), as well as a sensing hardware, such as a camera, radar, LiDAR, etc., for capturing visual data associated with the assets on a parcel. The mobile computing device 102 may additionally include a positioning subsystem for determining its global and/or local position. As an example, if a field technician brings the mobile computing device 102 to a parcel of property, he/she may utilize the sensing hardware to capture imagery of the parcel. This imagery may be utilized to determine the number of assets on the parcel, the types of assets, the age of the assets, the current value of the assets, the future value of the assets, etc.

The remote computing device 104 may be configured as a personal computer, laptop, server, tablet, mobile device, and/or other computing device that includes the hardware and provides the functionality provided herein. As described above, the remote computing device 104 may be configured to receive data from the mobile computing device 102, the administrator computing device 106 and/or the robotic vehicle 108 and process that data for providing the results described herein. As such, the remote computing device 104 may include a plurality of components (described in more detail with reference to FIG. 23), such as a memory component 140. The memory component 140 may be configured as read access memory (RAM), read-only memory (ROM), registers, etc. The memory component 140 may be configured to store logic or other computer-readable instructions, such as data acquisition logic 144a and analytics logic 144b. The data acquisition logic 144a may include instructions for acquiring data from the mobile computing device 102, the administrator computing device 106, the robotic vehicle 108, and/or third party resources and databases not explicitly depicted in FIG. 1.

As an example, the data acquisition logic 144a may receive location data from the mobile computing device 102 and/or robotic vehicle 108 for determining a parcel of property of interest. As another example, the data acquisition logic 144a may cause the remote computing device 104 to scrape the internet for property data from publicly available resources. The data acquisition logic 144a may similarly receive image data from the mobile computing device 102 and/or the robotic vehicle 108 for the inventory of assets on the parcel. In some embodiments, the data acquisition logic 144a may cause the remote computing device 104 to receive user input from the mobile computing device 102 and/or the administrator computing device 106 for the analytics logic 144b to execute actions based on that input.

The analytics logic 144b may utilize data received and processed by the data acquisition logic 144a, as described in more detail below. As an example, the analytics logic 144b may cause the remote computing device 104 to utilize machine learning and/or other models to inventory (or audit) assets on the parcel. As an example, the mobile computing device 102 and/or the robotic vehicle 108 may capture visual data of assets on a parcel. In some embodiments, the remote computing device 104 can utilize this data to provide a 3-dimensional map of the assets, along with species (or type), age, health, value, etc. of those assets. In the timber industry, a determination may then be made regarding which assets should be harvested (or cut) to realize value now, to decrease fire risk on the parcel, and/or to maintain sustainability in the future. In some embodiments, the analytics logic 144b may additionally cause the remote computing device 104 to cause the robotic vehicle 108 to automatically and without human interaction begin harvesting the identified assets. In some embodiments the remote computing device 104 may commission other hardware to perform this task. It should also be noted that some embodiments may be configured such that at least a portion of the computing described with reference to the remote computing device 104 is embodied in the mobile computing device 102, the administrator computing device 106, and/or the robotic vehicle 108.

The administrator computing device 106 may be configured as a desktop computer, laptop, tablet, mobile device, server, etc. In some embodiments, the administrator computing device 106 may be configured to receive user input regarding contacting landowners, commissioning agreements, contacting loggers, etc.

The robotic vehicle 108 may be configured as one or more aerial drones, terrestrial drones, aquatic drones, etc. that operate with or without human intervention. In some embodiments, the robotic vehicle 108 may be equipped with sensing hardware for scanning a parcel to inventory (or audit) the assets therein. In some embodiments, the robotic vehicle 108 may include harvesting hardware for harvesting the identified assets, which may include cutting, limbing, dragging, and/or hauling. In some embodiments, the robotic vehicle 108 may be configured for virtual and/or physical marking of assets (e.g., trees for cutting). Virtual marking may include identifying an asset, identifying the location of that asset, and sending that data with a predetermined pin to the remote computing device, such that the remote computing device 104 can identify and tag the assets being marked. Some embodiments may include attaching a physical marker (flag, paint, etc.).

It should be understood that the mobile computing device 102 and the robotic vehicle 108 are both mobile devices. While these devices function differently, either or both may be utilized on a parcel to perform an audit of assets therein.

FIG. 2 depicts a mobile interface 230 for analyzing agricultural industry areas, according to embodiments provided herein. As illustrated, embodiments may be configured to determine and render an image of one or more parcels 238 of land (or candidate parcels) in a map section 232 of the mobile interface 230 (which may be provided by the mobile computing device 102 of FIG. 1). This determination may be made from publicly available databases. Also determined and provided are acreages of each parcel. The map section 232 may be provided in response to selection of a map option 234a. A parcels option 234b, an add option 234c, an activity option 234d, and a more option 234e are also provided. In a map layers section 236, a user may select various layers to apply to the map. As an example, a parcels layer option may be provided to show the outline of parcels, the colors may be provided in response to selection of the TimberSync orders layer option. A teammates layer option may provide the current location of team members on the map section 232.

As described above, embodiments provided herein may be configured to automatically identify one or more parcels that may have potential for timber harvesting (or other natural resource utilization). To this end, some embodiments may be configured to use the satellite imagery of a predetermined area, as well as topography maps, ownership maps, etc. to determine candidate parcels, such as parcels 238a, 238b, 238c. Using image analysis algorithms, the remote computing device 104 (FIG. 1) may be configured to determine asset density, asset type, asset age, ease of access, and/or other data that may be helpful in such a determination. Specifically referring to FIG. 2, the remote computing device 104 may classify parcel 238a as having a lower density of timber than parcel 238b or parcel 238c. Similarly, parcel 238c may be determined to have a lower timber density than parcel 238b. Access may be roughly equal to each parcel as it appears there are roads adjacent to each parcel. As such, the remote computing device 104 may use these value parameters to categorize parcel 238b as a high priority, parcel 238c as a medium priority, and parcel 238a as a lower priority.

It should also be understood that other value parameters may weigh into these priority rankings. As an example, if the remote computing device 104 determines that the parcel 238c has an owner with a profile that suggest he/she may be more willing to cut timber, the priority of the parcel 238c may be adjusted. Such a determination may be made based on a history of cutting timber, a determination regarding whether parcel 238c is a primary residence, a determination regarding whether the owner is a resident of the county, etc.

FIG. 3 depicts another mobile interface 330 for providing data related to one or more parcels for analysis, according to embodiments provided herein. As illustrated, in response to selection of the parcels option 234b from FIG. 2, the mobile interface 330 may be provided. The user interface may provide a listing of all parcels under an all parcels option 332a. An image of the parcel, as well as an owner, an acreage, as well as an action that has been performed to acquire permission to harvest timber. Under an orders option 332b, parcels that have orders may be listed. Under the mailed option 332c, a listing of parcels that have been mailed offers may be provided. Under a visited option 332d, a listing of parcels that have been visited by representatives may be provided. In response to selection of a map view option 334, the parcels may be provided in a map configuration, similar to FIG. 2.

FIG. 4 depicts a mobile interface 430 for providing data related to a particular parcel, according to embodiments provided herein. In response to selecting a parcel from the mobile interface 330 from FIG. 3, the mobile interface 430 may be provided. As illustrated, the mobile interface 430 may provide a map portion 432, which depicts a satellite image of the selected parcel, highlighting the boundary, as well as indicating an acreage. Also provided is an owner section 434, which provides the name of the current owner and/or past owners, an acreage, and a location.

Also provided is a timber summary section 436. As described above, embodiments may be configured to utilize satellite imagery and/or other resources to audit the assets on a parcel. This may be supplemented by a user and the mobile computing device 102 physically present on the parcel and capturing imagery. Some embodiments may utilize the robotic vehicle 108 to capture imagery. Regardless, with the imagery data, the remote computing device 104 can determine the type of timber on the property, the estimated board feet of that timber, an estimated time until ready, and a likely last harvest.

More specifically, the remote computing device 104 may utilize machine learning algorithms to determine the type(s) of timber on the parcel. While FIG. 4 depicts only pines and hardwoods, some embodiments may be configured to provide detailed numbers of trees for each variety detected. Embodiments may also determine the thickness of trunks and the height of the trees to determine the estimated number of board feet. Based on the determined varieties and sizes of the trees, these embodiments may additionally estimate a time to readiness.

Also provided in the mobile interface 430 is an outreach history section 438. The outreach history section 438 may provide an accounting of the outreach that has been provided to the owner of the identified parcel. Also provided is a parcel notes section 440 for a user to add notes associated with the parcel. Mobile interface 430 may also provide a recent activity section 442 for providing the actions that most recently occurred with the parcel. Also provided are a directions option 444 and an add assessment option 446.

FIG. 5 depicts a mobile interface 530 for providing a parcel assessment, according to embodiments provided herein. In response to selection of the add assessment option 446 from FIG. 4, the mobile interface 530 may be provided. As illustrated, the mobile interface 530 may provide a parcel data section 532 for providing owner name, acreage, location, date mailed, etc. A commercial decision section 534 may also be provided. Specifically, embodiments of the remote computing device 104 may be configured to determine whether the value of the timber on the selected parcel, minus the cost of cutting and extracting warrants harvesting. The mobile computing device 102 may assess the inventory of trees on the property, looking at projected timber prices to determine the value of the trees. Additionally, the mobile computing device 102 may look at accessibility of the trees to a roadway or other path, topography of the parcel, easements required, etc. to determine the costs of cutting and removing the trees. If the net value exceeds a predetermined threshold, the parcel may be worth harvesting. If not, the parcel may not be worth harvesting. If there are variables that make the value difficult to accurately determine, the remote computing device 104 may select the uncertain option. In some embodiments, the remote computing device 104 may additionally provide the category of missing information needed to make the assessment.

Also provided is a future opportunity section 536. While the parcel may not have enough value for harvesting now, due to smaller trees on the parcel, an opportunity at a future time may exist. The remote computing device 104 may make this determination based on similar factors as provided in commercial decision section 534, but further determining the density of seedlings or other young trees, determining a likely time until those young trees will be ready for harvesting, and projecting a likely price for those trees at that time. If this projected future value exceeds a predetermined threshold, there might be a future opportunity. If there are variables that make the value difficult to accurately determine, the remote computing device 104 may select the uncertain option and may indicate a category of the missing data needed to make a decision. If the remote computing device 104 determines that a future opportunity likely exists, the remote computing device 104 may provide a likely time period for readiness in section 538.

Also provided is a species observed section 540. As illustrated, based on publicly available satellite imagery, imagery data from the mobile computing device 102 (FIG. 1) and/or data from the robotic vehicle 108, the remote computing device 104 may audit the timber on the candidate parcel and list the different species in the species observed section 540.

FIG. 6 depicts a mobile interface 630 for providing a waypoint on a parcel, according to embodiments provided herein. In response to selection of the add option 234c, the mobile interface 630 may be provided. As illustrated, the mobile interface 630 includes a map section 632 for providing a parcel. The map section 632 may provide a selected parcel, as well as one or more pins that may be placed in the parcel. The types of pins may include a tree pin 634a, an access point pin 634b, a landing point pin 634c, a skid trail pin 634d, a boundary pin 634e, a hazard pin 634f, and a point of interest pin 634g. A user of the mobile computing device may place pins 102, such as when located at a particular location. As an example, if a user of the mobile computing device 102 sees a specimen tree, he/she can place a tree pin 634a on that location. Similarly some embodiments may be configured for the remote computing device 104 to analyze image data from the mobile computing device 102 and/or the robotic vehicle 108 and place pins automatically. As described above, some embodiments of the robotic vehicle 108 may be configured to identify particular items when on the parcel and automatically virtually mark those items on the map section 632.

Also provided is a details section 636. The details section 636 may be provided for the mobile computing device 102, the remote computing device 104, the robotic vehicle 108, and/or a user to provide details regarding the pin that has been placed. Illustrated in the mobile interface 630, if a tree pin 634a is placed, the tree species, the diameter at breast height (DBH), the height, and an indication of whether the tree has been marked for cut is provided. Also provided is a status section 638, where the stat us may include whether the tree was observed, cruised, marked, cut, skidded, or picket up. A notes section 640 is provided for user notes. A save option 642 is provided to save the waypoint.

FIG. 7 depicts a mobile interface 730 for adding content to a parcel profile, according to embodiments provided herein. In response to selection o the add option 234c from FIG. 2, the mobile interface 730 may be provided. The mobile interface 730 may include a parcel assessment option 732, a waypoint option 734, a photo option 736, a note option 738, an access point option 740, and a boundary option 742. Specifically, some embodiments may be configured for the remote computing device 104 and/or other device to automatically add one or more of these features. The mobile interface 730 may permit a user to manually add the features.

FIG. 8 depicts a mobile interface 830 for monitoring activity for a parcel, according to embodiments provided herein. In response to selection of the activity option 234d, the mobile interface 830 may be provided. As illustrated, the mobile interface 830 may provide a listing of activities that have occurred for the selected parcel. Depending on the particular embodiment, the activities may be performed via a user interacting with the mobile computing device 102, a user interacting with the administrator computing device 106, the robotic vehicle 108 automatically interacting on the parcel, and/or activities performed by the remote computing device 104.

FIG. 9 depicts a mobile interface 930 for providing additional options for a parcel, according to embodiments provided herein. In response to selection of the more option 234e, the mobile interface 930 may be provided. As illustrated, the mobile interface 930 may provide a plurality of options, including a pipeline option 932 for a user to view and manage a pipeline.

FIG. 10 provides a mobile interface 1030 for providing a pipeline for a parcel, according to embodiments provided herein. In response to a user selection of the pipeline option 932, the mobile interface 1030 may be provided. As illustrated, the mobile interface 1030 may provide a listing of parcels to which the user is affiliated. The parcels listed in the pipeline of mobile interface 1030 may be classified as a new lead, initial review, due diligence, offer extended, under contract, and closed. Other options may also be provided.

FIG. 11 depicts a desktop interface 1130 for providing a map related to one or more parcels for analysis, according to embodiments provided herein. As illustrated, the desktop interface 1130 may be viewed on the administrator computing device 106 (FIG. 1) and corresponds with many of the features of the mobile interface 230 from FIG. 2. As illustrated, the desktop interface 1130 may include a map section 1132, as well as a sidebar. The sidebar may include a map option 1134a, a parcel option 1134b, an orders option 1134d, a mailed option 1134e, an activity option 1134f, a team option 1134g, a reports option 1134h, and a settings option 1134i. Also provided are a map layers section 1136, a map tools section 1138, and a filters section 1140.

The map layers section 1136 may be configured to highlight parcels, orders, mailed orders, teammates, roads, topography, timber type, slope, and LiDAR. The map tools section 1138 may provide a measure option, an area option, and a waypoint option. The filters section 1140 may provide options to filter parcels and/or layers based on one or more criteria.

FIG. 12 depicts a desktop interface 1230 for providing a parcel assessment, according to embodiments provided herein. In response to selection of the parcel option 1134b, the desktop interface 1230 may be provided. As illustrated, the desktop interface 1230 may provide a listing of parcels that are being analyzed. The parcels may be organized by parcel ID, owner, county, acreage, status, last activity, and/or actions. Also provided are an import parcel option 1232 and an add parcel option 1234.

FIG. 13 depicts a desktop interface 1330 for providing a pipeline of parcels for analysis, according to embodiments provided herein. In response to selection of a pipeline option 1134c, the desktop interface 1330 may be provided. The desktop interface 1330 may provide a pipeline of parcels, which may be categorized via a new lead category 1332a, an initial contact category 1332b, an assessment category 1332c, a proposal category 1332d, or a won category 1332e. Also provided is an add opportunity option 1334 for adding a new category for parcels.

FIG. 14 depicts a desktop interface 1430 for providing an order listing for a parcel, accordioning to embodiments provided herein. In response to selection of the orders option 1134d, the desktop interface 1430 may be provided. As illustrated, the desktop interface 1430 provides orders for various parcels. The orders may be organized by order name, county, parcels, order type, subscription start, mail dates, status, last mailed, owner or actions. Also provided are an export orders option 1432 and new order option 1434.

FIG. 15 depicts a desktop interface 1530 for providing an outreach history for a parcel, according to embodiments provided herein. In response to selection of the mailed option 1134e, the desktop interface 1530 may be provided. As illustrated, the desktop interface 1530 may provide parcels that have been sent mailings or other outreach. The parcels may be organized by order group, parcels, mailed date, order type, mailing method, status, or actions. Also provided are an export mailing option 1532 and a date range option 1534.

FIG. 16 depicts a desktop interface 1630 for providing an activity history for a parcel, according to embodiments provided herein. In response to selection of the activity option 1134f, the desktop interface 1630 may be provided. As illustrated, a list of recent activities associated with one or more parcel may be provided.

FIG. 17 depicts a desktop interface 1730 for providing a team listing for a parcel, according to embodiments provided herein. In response to selection of the team option 1134g, the desktop interface 1730 may be provided. As illustrated, a listing of team members may be provided, which may be organized by user, rule, team, last active, status, or actions. Also provided are an invite user option 1732 and a new user option 1734.

FIG. 18 depicts a desktop interface 1830 for providing a reports listing for a parcel, according to embodiments provided herein. In response to selection of the reports option 1134h, the desktop interface 1830 may be provided. As illustrated, the desktop interface 1830 may provide a listing of reports, which may be organized according to report name, category, type, last run, owner, or actions. Also provided are a schedule report option 1832 and a new report option 1834.

FIG. 19 depicts a desktop interface 1930 for providing system settings, according to embodiments provided herein. In response to selection of the settings option 1134i, the desktop interface 1930 may be provided. As illustrated, the desktop interface 1930 may provide various system options.

FIG. 20 depicts a flow diagram for analyzing agricultural industry areas, according to embodiments provided herein. As illustrated in block 2050, the user interfaces provided in FIGS. 2-19 may provide a plurality of different internal functions. This internal application infrastructure may communicate with the analytics logic 144b (FIG. 1) on the remote computing device 104. The analytics logic 144b may embody an application program interface (API) 2052. The API 2052 may access the parcel data 2338a and the third party data 2338b (FIG. 23), which may be embodied as a shared database and core platform 2054. The shared database and core platform 2054 may include parcel and landowner master data, business and pricing data, order and mailings, users and accounts, and events and history. The shared database and core platform may also include and/or access scout-specific activity data 2056.

Also provided in FIG. 20 is a data and value flow 2058. In block 1, the data and value flow 2058 may include selecting and selling parcel opportunities. In block 2, work in the field may be performed and processed. In block 3, feedback may be synced through the API 2052. In block 4, intelligence may be improved. The data and value flow 2058 may then utilize that data to improve future operations. In some embodiments, the feedback received in block 3 is structured and used to update parcel scoring models, confidence levels, and future targeting decisions in block 4.

FIG. 21 depicts a flowchart for analyzing agricultural industry areas, according to embodiments provided herein. As illustrated in block 2150, data associated with a plurality of parcels of land may be received. In some embodiments, the data may be associated with the plurality of parcels of land includes satellite imagery of the plurality of parcels of land. In block 2152, a candidate parcel for asset extraction may be determined from the data associated with the plurality of parcels of land. In still some embodiments, determining the candidate parcel includes determining a plurality of value parameters for the plurality of parcels of land based on a plurality of assets on the plurality of parcels of land, comparing each of the plurality of value parameters, and determining which of the plurality of value parameters meets a predetermined threshold. In block 2154, a mobile device may be commissioned to the candidate parcel to perform an audit (or inventory) of the plurality of assets on the candidate parcel.

In some embodiments, the plurality of assets may include a plurality of trees. In block 2156, a determination may be made regarding whether the audit is favorable. Determining whether the audit is favorable may include determining whether the value meets or exceeds a predetermined value, after costs are accounted. In block 2158, a likelihood of a landowner granting permission to remove at least a portion of the plurality of assets on the candidate parcel may be determined. As discussed above, this may involve determining whether the landowner is a first generation owner, whether the candidate property is the primary residence of the landowner, determining whether the landowner has granted permission in the past, etc. In block 2160, permission to remove at least a portion of the plurality of assets on the candidate parcel may be granted. In block 2162, in response to acquiring permission to remove at least a portion of the plurality of assets on the candidate parcel, the portion of the plurality of assets may be removed. In some embodiments, selection criteria for a next candidate parcel for timber extraction may be automatically modified, based on an accuracy of the value parameters.

FIG. 22 depicts another flowchart for analyzing agricultural industry areas, according to embodiments provided herein. As illustrated in block 2250, remote data associated with a plurality of parcels may be received. The remote data may include parcel data and landowner data. In block 2252, a parcel attribute of the plurality of parcels may be generated, based on the parcel data. In block 2254, a first parcel of the plurality of parcels may be selected, based on the parcel attribute. In block 2256, structured field observations associated with the first parcel may be received. The structured field observations may include categorical inputs and quantitative inputs. In block 2258, the parcel attribute may be updated based on the structured field observations. In block 2260, the landowner data may be associated with the first parcel, where the landowner data is conditionally linked to the first parcel based on ownership. In block 2262, the structured field observations associated with the first parcel may be reconciled to determine a confidence level. In block 2264, a parcel scoring model may be applied to the first parcel based on the structured field observations. In block 2266, selection criteria of a second parcel and/or or targeting decisions may be automatically modified based on the parcel attribute and the parcel scoring model of the first parcel.

FIG. 23 depicts the remote computing device 104 for analyzing agricultural industry areas, according to embodiments provided herein. As illustrated, the remote computing device 104 includes a processor 2330, input/output hardware 2332, a network interface hardware 2334, a data storage component 2336 (which stores parcel data 2338a, third party data 2338b, and/or other data), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the remote computing device 104 and/or external to the remote computing device 104.

The memory component 140 may store operating logic 2342, the data acquisition logic 144a and the analytics logic 144b. Each of these logic components may include a plurality of different pieces of logic, each of which may be embodied as a computer program, firmware, and/or hardware, as an example. A local interface 2346 is also included in FIG. 23 and may be implemented as a bus or other communication interface to facilitate communication among the components of the remote computing device 104.

The processor 2330 may include any processing component operable to receive and execute instructions (such as from a data storage component 2336 and/or the memory component 140). As described above, the input/output hardware 2332 may include and/or be configured to interface with speakers, microphones, and/or other input/output components.

The network interface hardware 2334 may include and/or be configured for communicating with any wired or wireless networking hardware, including an antenna, a modem, a LAN port, wireless fidelity (Wi-Fi) card, WiMAX card, mobile communications hardware, transceiver, and/or other hardware for communicating with other networks and/or devices. From this connection, communication may be facilitated between the remote computing device 104 and other computing devices.

The operating logic 2342 may include an operating system and/or other software for managing components of the remote computing device 104. As discussed above, the data acquisition logic 144a may be configured to cause the processor 2330 to acquire data from one or more sources, as provided herein. The analytics logic 144b may be configured to cause the processor 2330 to make various determinations, projections, and predictions, as well as actuate the robotic vehicle 108 to survey a candidate parcel and/or to mark or remove assets.

It should be understood that while the components in FIG. 23 are illustrated as residing within the remote computing device 104, this is merely an example. In some embodiments, one or more of the components may reside external to the remote computing device 104 or within other devices, such as the mobile computing device 102, and administrator computing device 106, and/or the robotic vehicle 108, depicted in FIG. 1. It should also be understood that, while the remote computing device 104 is illustrated as a single device, this is also merely an example. In some embodiments, the data acquisition logic 144a and/or the analytics logic 144b may reside on different computing devices.

As an example, one or more of the functionalities and/or components provided herein may be provided by the remote computing device 104, the mobile computing device 102, the administrator computing device 106, and/or the robotic vehicle 108. Depending on the particular embodiment, any of these devices may have similar components as those depicted in FIG. 23. To this end, any of these devices may include logic for performing the functionality provided herein.

Additionally, while the remote computing device 104 is illustrated with the data acquisition logic 144a and the analytics logic 144b as separate logical components, this is also an example. In some embodiments, a single piece of logic may provide the described functionality. It should also be understood that while the data acquisition logic 144a and the analytics logic 144b are provided herein as the logical components, this is also an example. Other components may also be included, depending on the embodiment.

As illustrated above, various embodiments analyzing agricultural industry areas are disclosed. These embodiments not only improve the technical field of computerized parcel asset tracking but also allow offer a practical application of automatically engaging in cutting of timber or otherwise harvesting an asset.

While particular embodiments and aspects of the present disclosure have been illustrated and provided herein, various other changes and modifications can be made without departing from the spirit and scope of the disclosure. Moreover, although various aspects have been provided herein, such aspects need not be utilized in combination. Accordingly, it is therefore intended that the appended claims cover all such changes and modifications that are within the scope of the embodiments shown and provided herein.

It should now be understood that embodiments disclosed herein include systems, methods, and non-transitory computer-readable mediums for analyzing agricultural industry areas. It should also be understood that these embodiments are merely exemplary and are not intended to limit the scope of this disclosure.

What is claimed is:

1. A method for analyzing agricultural industry areas comprising:
receiving, by a computing device, data associated with a plurality of parcels of land, wherein the data associated with the plurality of parcels of land includes satellite imagery of the plurality of parcels of land;
determining, by the computing device, a candidate parcel for asset extraction from the data associated with the plurality of parcels of land, wherein determining the candidate parcel includes determining a plurality of value parameters for the plurality of parcels of land based on a plurality of assets on the plurality of parcels of land, comparing each of the plurality of value parameters, and determining which of the plurality of value parameters meets a predetermined threshold;
commissioning, by the computing device, a mobile device to the candidate parcel to perform an audit of the plurality of assets on the candidate parcel;
determining, by the computing device, whether the audit is favorable;
determining, by the computing device, a likelihood of a landowner granting permission to remove at least a portion of the plurality of assets on the candidate parcel;
acquiring, by the computing device, permission to remove at least a portion of the plurality of assets on the candidate parcel; and
in response to acquiring permission to remove at least a portion of the plurality of assets on the candidate parcel, utilizing the computing device to remove the portion of the plurality of assets.

2. The method of claim 1, wherein the plurality of assets include trees.

3. The method of claim 1, wherein performing the audit includes at least one of the following: utilizing the mobile device to physically mark and account for the portion of the plurality of assets or virtually mark and account for the portion of the plurality of assets.

4. The method of claim 1, wherein the mobile device is configured to automatically and without human interaction create at least one of the following on the candidate parcel: a tree pin, an access point pin, a landing point pin, a skid trail pin, a boundary pin, or a hazard pin.

5. The method of claim 1, wherein performing the audit includes at least one of the following: determining a height of the portion of the plurality of assets, determining a diameter at breast height (DBH) of the portion of the plurality of assets, determining a number of the portion of the plurality of assets, determining a species of the portion of the plurality of assets, determining a current value of the portion of the plurality of assets, or predicting a future value of the portion of the plurality of assets.

6. The method of claim 1, in response to the audit not being favorable, predicting a future time that the audit would be favorable.

7. The method of claim 1, wherein the plurality of value parameters include at least one of the following: a density of the plurality of assets on the candidate parcel, a cost to remove the plurality of assets on the candidate parcel, or an accessibility of the candidate parcel.

8. A system for analyzing agricultural industry areas comprising:
a remote computing device that includes a processor and a memory component, the memory component storing logic that, when executed by the processor, causes the system to perform at least the following:
receive data associated with a plurality of parcels of land, wherein the data associated with the plurality of parcels of land includes satellite imagery of the plurality of parcels of land;
determine a candidate parcel for timber extraction from the data associated with the plurality of parcels of land, wherein determining the candidate parcel includes determining a plurality of value parameters for the plurality of parcels of land based on a plurality of trees on the plurality of parcels of land, comparing each of the plurality of value parameters, and determining which of the plurality of value parameters meets a predetermined threshold;
commission a mobile device to the candidate parcel to perform an audit of the plurality of trees on the candidate parcel;
determine whether the audit is favorable;
acquire permission to remove at least a portion of the plurality of trees on the candidate parcel; and
in response to acquiring permission to remove at least a portion of the plurality of trees on the candidate parcel, cause removal of the portion of the plurality of trees.

9. The system of claim 8, wherein performing the audit includes at least one of the following: utilizing the mobile device to physically mark and account for the portion of the plurality of trees or virtually mark and account for the portion of the plurality of trees.

10. The system of claim 8, further comprising the mobile device, wherein the mobile device includes at least one of the following: a robotic vehicle or a mobile computing device.

11. The system of claim 8, wherein the mobile device is configured to automatically and without human interaction create at least one of the following on the candidate parcel: a tree pin, an access point pin, a landing point pin, a skid trail pin, a boundary pin, or a hazard pin.

12. The system of claim 8, wherein performing the audit includes at least one of the following: determining a height of the portion of the plurality of trees, determining a diameter at breast height (DBH) of the portion of the plurality of trees, determining a number of the portion of the plurality of trees, determining a species of the portion of the plurality of trees, determining a current value of the portion of the plurality of trees, or predicting a future value of the portion of the plurality of trees.

13. The system of claim 8, wherein the logic causes the system, in response to the audit not being favorable, to predict a future time that the audit would be favorable.

14. The system of claim 8, wherein the plurality of value parameters include at least one of the following: a density of the plurality of trees on the candidate parcel, a cost to remove the plurality of trees on the candidate parcel, or an accessibility of the candidate parcel.

15. The system of claim 8, wherein causing removal of the portion of the plurality of trees includes automatically and without human intervention command the mobile device to cut and remove the portion of the plurality of trees.

16. A system for analyzing agricultural industry areas comprising:
a robotic vehicle for automatically and without human intervention traversing a candidate parcel; and
a remote computing device that includes a processor and a memory component, the memory component storing logic that, when executed by the processor, causes the system to perform at least the following:
receive data associated with a plurality of parcels of land, wherein the data associated with the plurality of parcels of land includes satellite imagery of the plurality of parcels of land;
determine the candidate parcel for timber extraction from the data associated with the plurality of parcels of land, wherein determining the candidate parcel includes determining a plurality of value parameters for the plurality of parcels of land based on a plurality of trees on the plurality of parcels of land, comparing each of the plurality of value parameters, and determining which of the plurality of value parameters meets a predetermined threshold;
commission the robotic vehicle to perform an audit of the plurality of trees on the candidate parcel;
determine whether the audit is favorable;
acquire permission to remove at least a portion of the plurality of trees on the candidate parcel;
in response to acquiring permission to remove at least a portion of the plurality of trees on the candidate parcel, cause removal of the portion of the plurality of trees; and
automatically modify selection criteria when determining a next candidate parcel for timber extraction, based on an accuracy of the value parameters.

17. The system of claim 16, wherein performing the audit includes at least one of the following: utilizing the robotic vehicle to physically mark and account for the portion of the plurality of trees or virtually mark and account for the portion of the plurality of trees.

18. The system of claim 16, wherein the robotic vehicle is configured to automatically and without human interaction create at least one of the following on the candidate parcel: a tree pin, an access point pin, a landing point pin, a skid trail pin, a boundary pin, or a hazard pin.

19. The system of claim 16, wherein performing the audit includes at least one of the following: determining a height of the portion of the plurality of trees, determining a diameter at breast height (DBH) of the portion of the plurality of trees, determining a number of the portion of the plurality of trees, determining a species of the portion of the plurality of trees, determining a current value of the portion of the plurality of trees, or predicting a future value of the portion of the plurality of trees.

20. The system of claim 16, wherein the plurality of value parameters include at least one of the following: a density of the plurality of trees on the candidate parcel, a cost to remove the plurality of trees on the candidate parcel, or an accessibility of the candidate parcel.

21. A method comprising:
receiving, by a computing device, remote data associated with a plurality of parcels, wherein the remote data includes parcel data and landowner data;
generating, by the computing device, a parcel attribute of the plurality of parcels, based on the parcel data;
selecting, by the computing device, a first parcel of the plurality of parcels, based on the parcel attribute;
receiving, by the computing device, structured field observations associated with the first parcel, wherein the structured field observations include categorical inputs and quantitative inputs;
updating, by the computing device, the parcel attribute based on the structured field observations;
associating, by the computing device, the landowner data with the first parcel, wherein the landowner data is conditionally linked to the first parcel based on ownership;
reconciling, by the computing device, the structured field observations associated with the first parcel to determine a confidence level;
applying, by the computing device, a parcel scoring model to the first parcel based on the structured field observations; and
automatically modifying, by the computing device, selection criteria of a second parcel based on the parcel attribute and the parcel scoring model of the first parcel.
